(19) United States
(12) Patent Application Publication
(10) Pub. No.: US 2006/0144506 A1
(43) Pub. Date: Jul. 6, 2006

(54) Molded fragrant applique and process

(76) Inventor: Gilbert Ynzunza, Los Angeles, CA (US)

Correspondence Address: Thomas W. Cook;Thomas Cook Intellectual Property Attorneys, P.O. Box 1989, 3030 Bridgeway, Suite 425-430, Sausalito, CA, 94965, US

(21) Appl. No.: 11/027,074

(22) Filed: Dec. 31, 2004

(51) Int. Cl. B29C 37/00

(52) U.S. Cl. 156/232; 156/245

(57) ABSTRACT

A method for producing stickers, appliques, and other transfers from commonly available base and fragrance materials, the transfers having desirable shapes and colors and a three dimensional (3-D) appearance, and the transfers having in addition a fragrance or scent which may be varied in its intensity depending on the fragrance used, its percentage composition when mixed in the base, and its position within specific areas formed in the transfer, whereby the completed transfer may carry images having a 3-D appearance and a scent or scents, the images may be of unlimited variability, from simple geometrical shapes to complex characters, from single-color, translucent, and nearly transparent, to multicolor images depicting complex cartoon characters, landscapes, and the like, and in which one scent may be located within one area of the transfer, while another scent (or scents) may be located within another area or areas of the same transfer, and individual scents of the transfer may be keyed to the individual shapes or colors of the transfer.

### TECHNICAL FIELD OF THE INVENTION

The present invention relates to appliques and stickers which may be applied to clothing, windows and other items. More particularly, the present invention relates to a new article of manufacture, consisting of an applique or a sticker (collectively “Transfers”) composed of material bearing a fragrance, aroma, or scent, and a process for creating such Transfers which allows application of such Transfer to clothing or other movable items. With the introduction of a backing and adhesive, Transfers may also be applied to both movable and immovable items, such as windows. The process utilizes known plastic compounds mixed with known fragrance oils, and the application of heat to the mixed compounds and oils in prescribed manners. Using the process of the present invention allows ornamentation or fragrance to be selectively concentrated in areas within the Transfers, thereby creating the appearance of three-dimensions (3-D) when the Transfers are viewed, and allowing separate areas of the finished Transfers to emit different scents. The compounds and oil mixtures may be formed into useful and ornamental shapes in molds when heated, as the mixture takes the shape of such molds. Such molded articles of manufacture may be released from their molds and directly applied to clothing and other items using pressure and heat. Such molded articles may also be released from their molds, coated with adhesive on one side, the adhesive covered, and the article stored for later use. Using the process of the present invention, a user may apply a Transfer to clothing, windows, or other items, and enjoy the fragrance emanating from the Transfer while he or she also enjoys its ornamental qualities.

### BACKGROUND ART OF THE INVENTION

Currently there is no apparatus or process to create Transfers having a fragrance, in which the Transfer may be directly applied to clothing and other items, or formed to allow the application of an adhesive and a backing for transport for use at another location. Apparatus and methods for making various stickers and inks are common in the prior art. Most such apparatus and methods involve “microcapsuled fragrance beads” introduced into inks and plastics for use of such inks and plastics in producing ornamental stickers and images. Some such apparatus and inventions even describe in the introduction of “free oil” (generally in the context of a “scratch-off material”), plastics having various viscosity, and the application of heat to transfer a sticker or applique to some movable item. However, no process of which the applicant is aware allows the production of Transfers capable of carrying images having a 3-D appearance and a scent or scents, wherein the images may be of unlimited variability, and the scents may be located in separate areas within the larger body of a Transfer. Thus, the present invention may be utilized to form Transfers having sub-millimeter thickness to inches in thickness, from simple geometrical shapes to complex characters, and from single-color, translucent, and nearly transparent, to multicolor images depicting complex cartoon characters, landscapes, and the like. At the same time, the present invention may be utilized to form these Transfers wherein one scent may be located within one area of a finished Transfer, while another scent (or scents) may be located withing another area (or areas) of the same finished Transfer.

In attempting to create articles of manufacture, such as stickers and appliques, and devise processes to form such articles, others have created stickers which have desirable characteristics, and processes which are necessary to such creation. Such articles, apparatus and methods within the prior art include:

U.S. Pat. No. 4,158,440 to Sullivan et al., which discloses device for releasing a volatile substance into the environment in a controlled manner, essentially an envelope having a permeable material through which the volatile substance may escape.

U.S. Pat. No. 4,254,179 to Carson, III et al., which discloses a method and apparatus for impregnating a porous foam product with an “encapsulated” fragrance using both heat and a vacuum to infuse the fragrance into the foam.

U.S. Pat. No. 4,283,011 to Spector, which discloses a sticker attachable to an article of clothing or other surface, the sticker having fragrance in an attached pad, and pressure-sensitive adhesive to facilitate attachment of the sticker to such articles of clothing or other surface.

U.S. Pat. No. 4,493,869 to Sweeny et al., which discloses a fragrance releasing applique having transparent or translucent substrate bearing microcapsules in a binder on one surface and an adhesive on the other surface.

U.S. Pat. No. 4,5282262 to Sweeny, which discloses a sheet material, which may be printed, having an adherent coating of microscopic, rupturable capsules, in a binder, capable of disbursing a fragrance.

U.S. Pat. No. 4,661,388 to Charbonneau, which discloses microencapsulated materials released by removing individual elements from a pad of sheets bonded by adhesive layers containing fragrance capsules.

U.S. Pat. No. 5,093,182 to Ross, which discloses sustained-release, perfume-containing coatings for advertising samplers, printed over ink images.

U.S. Pat. No. 5,114,735 to Rua, Jr et al., which discloses a scratch-off game piece containing “free-oil” fragrance which is released during the game play action.

U.S. Pat. No. 5,136,640 to Kim, which discloses an aromatic sticker for use in a telephone handset.

U.S. Pat. No. 5,817,385 to Stanislav, which discloses a removable scented tatoo with fragrance layer applied as the top-most layer of the tattoo during its manufacture.

U.S. Pat. No. 6,640,715 B1 to Watson et al., which discloses an oil-based scent mixed with a plastisol-type ink, which is applied cool to an article, using conventional screen print techniques, wherein body heat of a user releases the scent.

A method of manufacture commercially known as “The Flextran System, in which a clear base liquid, which may be colored, is introduced warm into the cavity of a mold, which mold is created to meet the requirements of a particular application, and the mold is heated in position on an article intended to receive a Transfer.

While the inventions disclosed in these prior patents fulfill their respective objectives, these prior patents do not describe or suggest appliques or stickers composed of known plastic compounds in combination with known fragrance oils, wherein the application of heat to the compounds and the oils in the manner prescribed herein produces useful and ornamental shapes in molds, and the shapes bear a fragrance, aroma, or scent. Nor do these prior patents disclose a process for creating such Transfers which allows near-permanent application of such Transfer to clothing or other movable items using heat and a mold. Nor do these prior patents disclose a process for producing scented appliques and stickers of such known plastic compounds in combination with known fragrance oils using such molds, wherein the applique or sticker may be coated with adhesive and a backing to allow transport of the applique or sticker for adhesion on a surface remote from the mold. By utilizing the process of the applicant set forth herein, one can manufacture Transfers having precisely the right characteristics to accomplish all these desirable ends.

### DISCLOSURE OF INVENTION

### Summary of the Invention

In its simplest form, this invention is a method to infuse fragrance oil into a base composed substantially of rubber or plastic. The fragrance oil will generally be referred to herein as the “Fragrance,” and the rubber or plastic into which it is infused will generally be referred to herein as the “Base.” The Base and Fragrance combined mixture is then transferred onto a substrate. In a first embodiment of this invention, the substrate may be clothing or other similar useful articles, and the Transfer is accomplished using heat. In a second embodiment, the substrate may be a window in a building or automobile, a wall, or any other non-movable surface. The substrate, whether clothing or other transportable articles, or window or other non-movable surface, will generally be termed herein the “Substrate.”

More specifically, a first embodiment of the present invention accomplishes its overall result (and overcomes some problems and disadvantages of the prior art) by the application of heat at various points in the process of the present invention, notably (1) prior to mixing of Base and Fragrance, (2) when the Base and Fragrance mixture has been placed within a mold, to cure the mixture, and thereby solidify it into a unitary, finished Transfer having the desired shape, and (3) at the time the finished Transfer is released from the mold and bonded onto a tangible Substrate. At the time of its release from the mold, the Finished Transfer, now a unitary (though pliable) piece after the prior application of heat to these components separately, and after a second heating to cure the plastic or rubber of which the Transfer is composed is, with the third application of heat, bonded to the Substrate. The result is a Transfer, comprising a soft colorful design, with a Fragrance, bonded to a variety of Substrates, including but not limited to, Substrates of denim, fleece, cottons & blends, knits, polyester, vinyl, neoprene, Lycra, and some nylon blends.

A second embodiment of the present invention accomplishes generally the same overall result, in that it produces a Finished Transfer having characteristics similar to that of the first embodiment set forth above. However, in the second embodiment the Finished Transfer is not bonded to a Substrate by a final application of heat. Rather the heat is applied at only the first two points in the process of the first embodiment, notably (1) prior to mixing of Base and Fragrance, and (2) when the Base and Fragrance mixture has been placed within a mold, to cure the mixture, and thereby solidify it into a unitary, finished Transfer having the desired shape. Since the finished Transfer is not then again heated to release if from the mold and bond it onto a tangible Substrate, the finished Transfer may be removed from the mold as it cools, or at room temperature, either immediately or at a later time. Whether the finished transfer is removed from the mold immediately or stored in the mold for later use, the result of this process when the finished Transfer is removed from the mold is the creation of a unitary (though pliable) piece, which may be sewn onto a Substrate, or to which an adhesive may be applied for bonding to such Substrates.

If an adhesive is applied to the finished Transfer of the second embodiment, a paper or plastic cover is then generally applied against the adhesive, whereupon the finished Transfer is then in a condition to store for later use, or package for sale, or transport for use or sale at a distant location. Whether the finished Transfer is left without adhesive, and later sewed to a Substrate, or adhesive applied, the result is a Transfer having a soft colorful design, with a Fragrance, which may be secured to a variety of Substrates either by sewing the Transfer to the Substrate, or by first removing the paper or plastic backing, and then pressing the adhesive of the Transfer against the Substrate. As with the first embodiment set forth above, such Substrates may include denim, cottons, knits, and other materials as mentioned above, but such Substrates may also include windows, doors, automobiles, bicycles, and virtually any other object, and to paper, plastic, metal, glass, and virtually any other material. The finished Transfer is flexible enough to conform to the shapes of such objects, and the adhesive is strong enough to bond the Transfer to the materials from which such objects are made.

### OBJECTS OF THE INVENTION

A principal object of the present invention is to provide a process for incorporating fragrances, scents, aromas, or odors into appliques, stickers, and other Transfers, so that such fragrances, scents, aromas, or odors may be released over time so that a user may experience them when positioned in proximity to such Transfers.

A further principal object of the present invention is to provide a process for mixing fragrances, scents, aromas, or odors, colors, and other materials with a plastic or rubber base, so that such fragrances, scents, aromas, or odors may, using heat, be incorporated into such plastic or rubber base prior to forming a Transfer having a complex shape, and three dimensional appearance.

A further principal object of the present invention is to provide a process for mixing fragrances, scents, aromas, or odors with a plastic or rubber base, so that such fragrances, scents, aromas, or odors in such base may be positioned within only certain areas of a mold use for forming a Transfer from the mixed base and fragrance, so that different fragrances may be perceived from different areas of the finished Transfer.

A further principal object of the present invention is to provide a process for creating a finished Transfer having a fragrance, scent, aroma, or odor, composed of a plastic or rubber base and such fragrance, scent, aroma, or odor, which Transfer, through such process and a further application of heat, may be bonded to a variety of Substrates.

A further principal object of the present invention is to provide a process for creating a finished Transfer having a fragrance, scent, aroma, or odor, composed of a plastic or rubber base and such fragrance, scent, aroma, or odor, which Transfer, through such process and a further application of adhesive and backing, may transported or stored, for later bonding to a variety of Substrates.

### DETAILED DESCRIPTION OF PREFERRED EMBODIMENTS

In one embodiment of the present invention, a mold is first created. The mold may be made of any substance capable of maintaining its shape under the conditions of heat and pressure set forth below, but generally the mold will be formed of aluminum, iron, magnesium, or copper, or some alloy of these or other metals, such as brass. The mold is formed to meet specifications supplied by one interested in applying colorful and scented designs to clothing or other surfaces. Thus, for example, a t-shirt seller may impress the likeness of a cartoon character on the front of its t-shirts for eventual sale to youngsters, and the design in the mold may be created, perhaps by photo etching, from artwork supplied by such seller.

The mold in preferred embodiments is formed atypically from most molds, which have two sides, one or both of which have a cavity. In such typical molds the sides may be joined to produce a fluid tight cavity within, except for a channel into which fluid may be poured to fill such interior cavity (injection molded). While such molds may be used, the molds of preferred embodiments of the present invention are formed “open,” i.e., with a single solid side, into which a cavity corresponding to the design supplied by a manufacturer, and likely corresponding to its artwork, may be etched. Once the cavity of the mold is created by such etching, the mold may hold a fluid poured within the cavity if the mold is held open side up. The etching of the mold is preferably conducted in such fashion as to create shallower and deeper parts of the mold cavity. The variation in cavity depth is preferably conducted so that the appearance of a finished Transfer, once formed within the mold and applied to an article by the process of the present invention, may take on a three dimensional quality, simply because the finished Transfer is thicker in some spots and thinner in other spots.

Once a mold has been created by the above process, an organic Base consisting of (or capable of creating) a polymeric matrix is prepared. The Base may consist of primarily cellulose acetate dissolved in an organic solvent with a plasticizer, or it may consist of other organic compounds capable of liquefying at the temperatures set forth herein, but solidifying at room temperature, and bonding with a Substrate. A preferred Base material is generally the polyvinyl chloride (PVC) product commonly termed “plastisol” in most preferred embodiments of the present invention. There are many uses for PVC plastisol, and numerous formulations to meet the requirements of such uses, including plastisol for the dip coating and dip molding industries. However, the plastisol formulation appropriate for use as a Base in the present invention will generally become semi-fluid at about 120 Fahrenheit degrees, and will result in a Transfer which is, when cured at about 330 Fahrenheit degrees and cooled to room temperature, very soft and flexible. The Base can then also be enhanced in the present invention with glitter, pearl, metallic powders, glow-in-the-dark pigments, and the finish may be marbleized, textured and combined for distinctive results.

To the Base prepared according to the above specifications, a fragrance, aroma, scent, or odor is, in the present invention, next added. The fragrance, aroma, scent, or odor, which may be prepared prior to preparing the Base, is preferably in the form of a fragrance oil (the “Fragrance” set forth above), as in such form the Fragrance may be easily heated, stored, and otherwise handled in the process of the present invention. In this step, the Fragrance and the Base are each preheated to approximately 120 Fahrenheit degrees in a preferred embodiment of the present invention. It may be noted that a range of temperatures may be used in this step, as plastic materials which are appropriate for Base in the present invention melt over a range of temperatures, and those ranges vary with the precise formulation of each plastic compound. All mixing temperatures are anticipated by the present invention.

While Base and Fragrance at room temperature, or Base and Fragrance at different temperatures, may be mixed consistent with the process of the present invention, a preferred embodiment of the present invention includes mixing the Base and Fragrance at approximately the same temperature. Pouring cooler Fragrance into warm Base may tend to prematurely solidify, or “gel,” portions of the Base, with resultant incomplete mixing, while pouring hot Fragrance into cooler Base may tend to evaporate volatile aromatic compounds of the Fragrance before they are mixed with the Base. When in the present invention both the Base and the Fragrance are preheated before mixing to approximately the same temperature, the mixing of the Base and Fragrance proceeds smoothly.

Using this procedure, an optimal temperature may be chosen which liquefies or softens the Base to a semi-fluid state, so that the Base and Fragrance mixture may flow easily into the smallest etchings of the mold. At the same time, the optimal temperature is a temperature just high enough to produce the desired fluidity, as any increase above a temperature just necessary to accomplish this fluidity also increases premature loss of aromatic compounds from the Fragrance (before mixing) and the Base and Fragrance mixture (after mixing). For plastisol having the desired characteristics of softness and flexibility (after curing at about 330 degrees and cooling to room temperature), this optimal mixing temperature is about 120 Fahrenheit degrees. However, with improvements in plastisol, and with the introduction of new compounds having such characteristics at room temperature, other temperatures, particularly lower temperatures, may be possible for introduction of the Fragrance into the Base. As noted above, all mixing temperatures are within the scope of the present invention.

Once the Base and Fragrance of the present invention are mixed according to the procedure set forth above, the Base and Fragrance mixture is then poured into a mold constructed consistent with the description set forth above. The mold is, in the preferred embodiment of the present invention, also heated to approximately 120 Fahrenheit degrees for optimal performance given commercially available plastisol. At such temperature, the plastisol (or other suitable compound) will flow freely into the mold without solidification due to contact with a cooler mold. In some circumstances, however, a higher mold temperature may be used to good effect, as the optimal temperature for mixing Base and Fragrance, and the optimal temperature for creating a fluid state in the Base and Fragrance mixture, may be below the optimal temperature to allow the mixture to flow into the smallest etchings of the mold cavity. Heating the Base and Fragrance mixture somewhat may allow the mixture to fully fill such etchings, achieve a complete pour, and so provide all the detail of mold cavity. And while the mixture may be heated above its optimal mixing and pouring temperature to accomplish this complete pour, the preferred method is to bring the mold to a slightly higher temperature to heat the mixture directly in contact with the mold, thereby creating a less viscous layer of plastisol where it is needed, directly at or adjacent the fine etchings of the mold cavity. All mold filling temperatures are within the scope of the present invention.

In many preferred embodiments of the present invention, the preheating, mixing and pouring may be undertaken a number of times to fill a single mold cavity, generally in discrete volumes within the mixture as a whole. These volumes, or “Areas” of mixture, may be laid one above or over the other, or side by side within the mold, or in any fashion necessary to create the desired artistic effect. The number of iterations of these processes generally depends on the number of colors intended to stand out as discrete elements of the finished Transfer or, in the some embodiments of the present invention, the number of scents to be added to a Transfer (but kept separate one from the other). Thus, individual colors (mixed in Base), or individual Fragrances (mixed in Base) may be individually poured into the mold in such a fashion as to create local color concentrations, or localized scents, within various Areas of the mixture within the mold. As a result, a user may fill certain portions of the mold cavity and etchings with one color, or a combination of colors, or one or more Fragrances, while filling other portions of the mold cavity with another color (or colors) or Fragrances. This serial or preferential filling may be accomplished manually or by automated machinery. Such serial or preferential filling of the mold cavity or etchings may be used to create a variety of effects, prominent among them enhanced 3-D effect as some portions or lines of the finished Transfer are emphasized by one color over others. Other additives set forth above may also be introduced into the cavity and its etchings in Areas, creating yet other effects. Regardless of what other additive is eventually introduced to any individual Area poured into the mold, Fragrance may be mixed with the Base according to the process set forth above to the mixture for each Area individually, or to a larger batch of Base from which the Base of each Area is drawn. In the alternative, Fragrance may be added to Base used to pour only some Areas, or even just one Area, so that only some Areas of the finished Transfer will carry Fragrance. In this way, Fragrance may be concentrated in one or more layers, and released to the environment more slowly (or more quickly) as Fragrance is trapped beneath non-fragrance bearing layers (or resides in layer closest to the outer surface of the Transfer). In this way, different scents may be separated one from the other, and released to the environment so that a user may sniff different scents at different places of a single Transfer.

After Base and Fragrance mixture is poured into the cavity of the mold, whether in a single pour or in multiple pours in Areas as set forth above, the entire contents of the mold is then heated to solidify or cure it (“Cured” or “Curing”). An optimal temperature and time for Curing a Base and Fragrance mixture in a preferred embodiment of the present invention is about 330 Fahrenheit degrees, for about 30 seconds. However, it may be noted again that the plastic materials which are appropriate for Curing the contents of the mold Cure and solidify over a range of temperatures and times, and those ranges vary with the precise formulation of each plastic compound. All Curing temperatures are anticipated by the present invention. The Curing generally takes place in a “dryer,” which is a heating chamber capable of coming to Curing temperature in a reasonable period of time. With the application of the Curing temperature, the mixed Base and Fragrance then solidifies, whereupon the now-unitary Transfer piece may be cooled, generally while it resides in the mold. In most preferred embodiments of the present invention, the Transfer remains in the mold until it is either bonded to a Substrate (in a first preferred embodiment), or removed from the mold for application of adhesive and backing as set forth above, or simply removed and packaged for later attachment by sewing (or other means) to a desirable Substrate.

After the Base and Fragrance mixture, or variety of mixtures in Areas, substantially fills the cavity of the mold using the above processes, in one preferred embodiment a Substrate is then placed over a platen on a heat press, and the filled mold with Cured (or cooled) contents is placed against the Substrate. In this preferred embodiment, the cavity of the mold, with Cured contents, is presented to the Substrate from above, with the Substrate below, so the Substrate may be held in place with gravity alone, however the cavity of the mold and Substrate may also be reversed in position.

Once the mold and Substrate are in position, one against the other, in this preferred embodiment, the mold is heated for a time sufficient to soften the Base and Fragrance mixture. The degree to which the mixture is softened is optimally sufficient to allow some of the mixture within the mold to penetrate between the threads of an article of clothing when pressure is applied after bringing the mold and Substrate together, or conform to the irregularities found in the surface of the Substrate. On the other hand, the degree to which the mixture is softened is optimally less than sufficient to soften Base within segregated Areas within the mold, if any, to a liquid, as such temperatures may cause the colors and Fragrances within those Areas to run one to the next. The time necessary to accomplish the desirable softening of the contents of the mold depends on the rate energy is transferred to the mold, and heat holding capacity of the mold. However, using present heating technology (such as electrical wires running on 220 volts), and presently used materials for forming a mold (such as light aluminum, thick enough to hold its shape), a heating time of approximately 30 seconds is generally sufficient to soften the Base and Fragrance mixture (or mixtures, in separate Areas within the cavity of the mold) sufficient to cause some of the Base and Fragrance mixture (or mixtures) within the mold in contact with, or adjacent to, the Substrate to change to a semi-fluid state, so that it may move to positions between the threads or fibers of an article of clothing (or other workpiece), or conform to other textures found on the Substrate.

After the mold has been heated as described above, it may then be allowed to cool in place on the Substrate. The mold is then removed from the Substrate, in the process releasing the mold from the Base and Fragrance mixture, leaving the mixture attached to the Substrate as a now-finished (and attached) Transfer. The Transfer so created displays the detailed lines inherent in the etchings of the mold, the colors added to the Base and Fragrance mixture (or Areas of mixture), and the Fragrance added as the Transfer is created during the steps of the process set forth above. The image appearing on or from the Transfer, arising from the fine lines of the mold cavity, and accentuated by color layers, if any, creates a sharp raised image that displays fine detail and fine lines of the etchings within the mold, to at least two-point rule using present commercially available plastisol and mold etching technology, but capable of preserving much finer lines. As a result of this final step of the process of this preferred embodiment of the present invention, heating the Base and Fragrance mixture residing within the cavity of the mold while the mold is in contact with (and/or pressed against) the Substrate, causes the Transfer to be permanently bonded to the Substrate as some of the mixture penetrates between the threads or fibers of the Substrate, or conforms to other irregularities or texture of the Substrate, and then cools and solidifies around such threads or irregularities.

In a further refinement of the present invention, the process of the present invention is varied in a second embodiment of the invention by placing the mold on a hard, flat surface after the Base and Fragrance mixture substantially fills the cavity of the mold using the above processes, i.e., before placing the mold over a platen on a heat press, and instead of placing the mold against the Substrate. Once the mold and flat surface are in position, one against the other, the mold may be heated for a time sufficient to loosen the Transfer from the mold, allowing the Transfer to be easily released from the mold. The mold may then be removed from the flat surface, in the process leaving the Transfer on the flat surface, but not attached to it. In the alternative, the Transfer may be removed from the mold, before or after placing the mold on a flat surface, by application of pressure to an edge of the Transfer with an appropriate tool, by pulling the Transfer from the mold with suction, or by other means appropriate given the shape and resiliency of the Transfer.

The now finished, but unattached, Transfer of this second embodiment has, as in the prior embodiment, all the detailed lines inherent in the etchings of the mold, the colors added to the Base and Fragrance mixture (or Areas of mixture), and the Fragrance added as the Transfer is created during the steps of the process set forth above. An adhesive may then be attached to the finished Transfer, and a paper or plastic backing may be pressed over the adhesive. With the adhesive applied and backing in place, the Transfer is in a condition suitable for use, or sale to those users who may wish to apply the Transfer to their windows, doors, walls, floors, mugs, magnets, and other surfaces. Alternatively, a finished Transfer separated from the mold may be used without adhesive and backing, as when a user prefers to sew or glue the Transfer to an article or workpiece, or use other means to attach the Transfer to such article or workpiece, or when the manufacturer applies the a number of Transfers to a “sticker sheet,” and individual stickers die cut from the sheet.

Regardless of how the Transfer of this second embodiment is treated for attachment, whether adhesive and backing applied at the time of manufacture or the Transfer is left without adhesive and backing, the same serial or preferential filling of the mold cavity or etchings creates a variety of effects, prominent among them enhanced 3-D effect as some portions or lines of the finished Transfer are emphasized by one color over others. While other additives set forth above may also be introduced into the cavity and its etchings in separate Areas, creating yet other effects, Fragrance mixed with the Base as a whole or within Areas according to the process set forth above allows great variability in the shape, color, and smell of a single Transfer. Moreover, Transfers produced using the present invention may be stored or transported in the mold in which they are formed as well as removed from the mold before storing or transporting. In the mold, Transfers created using the present invention may be stored for only a few months, or the may sit in the mold for years before the Transfer is removed and used. The scent residing in Transfers created according to the present invention will emanate from the Transfers five years or more, while storing Transfers in a mold or packaged in plastic will greatly extend this life.

The more important features of the invention have thus been outlined, rather broadly, so that the detailed description thereof that follows may be better understood, and in order that the present contribution to the art may be better appreciated. Additional features of specific embodiments of the invention will be described below. However, before explaining preferred embodiments of the invention in detail, it may be noted briefly that the present invention substantially departs from pre-existing articles of manufacture and methods of the prior art, and in so doing provides the user with the highly desirable ability to produce a Transfer from commonly available materials, having the desirable characteristics noted herein, and in addition having a fragrance or scent which may be varied in its intensity depending on the percentage scent used in the Base, and its position in the Transfer where Areas are formed in the process of making a completed Transfer according to the process of the present invention. No process prior to the applicants allows the production of Transfers capable of carrying images having a 3-D appearance and a scent or scents, wherein the images may be of unlimited variability, and the scents may be located in separate Areas within the larger body of a Transfer. Thus, the present invention may be utilized to form Transfers having sub-millimeter thickness to inches in thickness, from simple geometrical shapes to complex characters, and from single-color, translucent, and nearly transparent, to multicolor images depicting complex cartoon characters, landscapes, and the like, in which one scent may be located within one Area of a finished Transfer, while another scent (or scents) may be located withing another Area (or Areas) of the same finished Transfer.

Moreover, because the locations of the colors and other visual effects may be controlled, and the locations of various scents may be individually controlled, parts of a finished Transfer having certain color characteristics may be keyed to emit one or more complimentary scents. For example, and without limitation, a Transfer depicting a bouquet of flowers, may display a rose shape, in red, which emits a rose scent, while also displaying an orchid shape, in white (or multicolored), which emits a pear blossom scent. The result is a Transfer varied in shape, color (or other characteristics), with a variety of scents, the individual scents of the Transfer often keyed to the individual shapes or colors of the Transfer.

Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. A method for making a transfer, comprising the steps of:
preheating a base to a temperature sufficient to bring the base to a semi-fluid state;
preheating a fragrance to approximately the temperature of the preheated semi-fluid base;
mixing the base and the fragrance at approximately the temperature of the preheated semi-fluid base;
pouring the preheated base and fragrance mixture into a mold;
heating the mold to a temperature sufficient to cure the base and fragrance mixture;
placing the cured base and fragrance mixture in the mold against a substrate having irregularities;
heating the mold sufficient to soften the cured base and fragrance mixture sufficiently to allow some of the base and fragrance mixture within the mold to conform to the irregularities of the substrate, thereby bonding the cured base and fragrance mixture to the substrate; and
removing the mold from the substrate, leaving the mixture bonded to the substrate.

2. The method for making a transfer of claim 1, in which the mold is preheated to approximately the temperature of the preheated semi-fluid base before the preheated base and fragrance mixture is poured into the mold.

3. The method for making a transfer of claim 1, in which the base and fragrance are preheated to approximately 120 Fahrenheit degrees.

4. The method for making a transfer of claim 1, in which the temperature sufficient to cure the base and fragrance mixture is approximately 330 Fahrenheit degrees.

5. The method for making a transfer of claim 1, in which the substrate is an article of clothing.

6. A method for making a transfer, comprising the steps of:
preheating a base to a temperature sufficient to bring the base to a semi-fluid state;
preheating a fragrance to approximately the temperature of the preheated semi-fluid base;
mixing the base and the fragrance at approximately the temperature of the preheated semi-fluid base;
pouring the preheated base and fragrance mixture into a mold;
placing the cured base and fragrance mixture in the mold against a substantially flat surface, to create a transfer having a substantially flat surface;
heating the mold sufficient to cure the base and fragrance mixture; and
removing the transfer having a substantially flat surface from the mold.

7. The method for making a transfer of claim 6, further comprising the steps of:
applying an adhesive to the substantially flat surface of the transfer; and
covering the adhesive applied to the substantially flat surface of the transfer with a backing.

8. The method for making a transfer of claim 6, further comprising the steps of:
applying an transfer to a sticker sheet; and
cutting the sticker sheet around the transfer to create a sticker.

9. The method for making a transfer of claim 6, in which the mold is preheated to approximately the temperature of the preheated semi-fluid base before the preheated base and fragrance mixture is poured into the mold.

10. The method for making a transfer of claim 6, in which the base and fragrance are preheated to approximately 120 Fahrenheit degrees.

11. The method for making a transfer of claim 6, in which the temperature sufficient to cure the base and fragrance mixture is approximately 330 Fahrenheit degrees.

12. The method for making a transfer of claim 6, in which the substrate is an article of clothing.

13. The method for making a transfer of claim 7, in which the mold is preheated to approximately the temperature of the preheated semi-fluid base before the preheated base and fragrance mixture is poured into the mold.

14. The method for making a transfer of claim 7, in which the base and fragrance are preheated to approximately 120 Fahrenheit degrees.

15. The method for making a transfer of claim 7, in which the temperature sufficient to cure the base and fragrance mixture is approximately 330 Fahrenheit degrees.

16. The method for making a transfer of claim 7, in which the substrate is an article of clothing.

17. A method for making a transfer, comprising the steps of:
mixing a base and a fragrance at approximately the temperature;
pouring the preheated base and fragrance mixture into a mold;
heating the mold to a temperature sufficient to cure the base and fragrance mixture;
placing the cured base and fragrance mixture in the mold against a substrate having irregularities;
heating the mold sufficient to soften the cured base and fragrance mixture sufficiently to allow some of the base and fragrance mixture within the mold to conform to the irregularities of the substrate, thereby bonding the cured base and fragrance mixture to the substrate; and
removing the mold from the substrate, leaving the mixture bonded to the substrate.

18. The method for making a transfer of claim 17, in which the mold is preheated to approximately the temperature of the base before the base and fragrance mixture is poured into the mold.

19. The method for making a transfer of claim 17, in which the temperature sufficient to cure the base and fragrance mixture is approximately 330 Fahrenheit degrees.

20. The method for making a transfer of claim 17, in which the substrate is an article of clothing.
